(19) United States
(12) Patent Application Publication
(10) Pub. No.: US 2011/0293385 A1
(43) Pub. Date: Dec. 1, 2011

(54) VEHICLE ADAPTED TO CARRY ELONGATE CARGO

(75) Inventors: Glenn E. Stahl, White Lake, MI (US); Joseph M. Polewarczyk, Rochester Hills, MI (US); Kevin G. Kolpasky, Oakland Township, MI (US); Raymond A. Beaufait, Macomb, MI (US)

(73) Assignee: GM GLOBAL TECHNOLOGY OPERATIONS, INC., Detroit, MI (US)

(21) Appl. No.: 12/790,420

(22) Filed: May 28, 2010

(51) Int. Cl. B60P 3/40

(52) U.S. Cl. 410/44

(57) ABSTRACT

A vehicle adapted to carry elongate cargo includes, but is not limited to, a body having a cargo support surface having a first opening. A first support member is housed within the first opening and is configured to move inwardly and outwardly with respect to the first opening. A first restraining member is connected to the first support member and oriented generally transversely thereto. The first restraining member is configured to move towards and away from the cargo support surface as the first support member moves inwardly and outwardly with respect to the first opening, and to compress the elongate cargo against the cargo support surface. The body is configured to engage the first support member and to inhibit the first support member from moving away from the body. The first restraining member and the cargo support surface cooperate to restrain the elongate cargo.

### TECHNICAL FIELD

The technical field generally relates to vehicles and more particularly relates to vehicles adapted to carry elongate cargo.

### BACKGROUND

Carrying cargo, such as a plank of wood or other elongate objects in a vehicle can present a variety of challenges. In the case where the length of the cargo exceeds the dimensions of the vehicle's cargo compartment, vehicle operators frequently must leave the cargo compartment open to accommodate the cargo. A vehicle operator may leave the hatch door of a sports utility vehicle or the trunk of a passenger car open and may allow the cargo to protrude out of the vehicle through the opening. In vehicles such as pickup trucks, the operator may lower the tailgate or, because of its open cargo compartment, the operator may keep the tailgate in a closed, upright position and lay the cargo over a top portion of the tailgate.

In these situations, unless the cargo is restrained, it may move laterally as the vehicle maneuvers. For example, a single two by four plank of wood leaning on the upper surface of a pickup truck's closed tailgate may slide from side to side along the tailgate as the vehicle turns left and right. During such maneuvers, the plank of wood may impact against the side walls of the cargo compartment. This can potentially cause damage to the vehicle, the cargo, or both.

In cases where the cargo is smaller than the dimensions of the cargo compartment, lateral movement of the cargo may also occur during vehicle maneuvers. For example, even if a plank of wood can fit lengthwise inside of the cargo compartment, it may have a width that is substantially less than the width of the cargo compartment and may slide from side to side as the vehicle turns left and right.

One common solution used in these situations is to secure the cargo with a tether, such as an elastic cord or a rope. However, this solution requires an operator to either permanently store the tether in the vehicle or to remember to place the tether in the vehicle on those occasions when the operator expects to carry elongate cargo. While adequate, this solution may be inconvenient for a vehicle operator.

### SUMMARY

Embodiments of a vehicle and a system adapted to carry elongate cargo are disclosed herein.

In an embodiment, the vehicle includes, but is not limited to, a body having a cargo support surface that is configured to support the elongate cargo. The cargo support surface has a first opening defined therein. A first support member is housed within the first opening and is configured to move inwardly and outwardly with respect to the first opening. A first restraining member is connected to the first support member and is oriented generally transversely thereto. The first restraining member is configured to move towards and away from the cargo support surface as the first support member moves inwardly and outwardly with respect to the first opening and further configured to compress the elongate cargo against the cargo support surface. The body is configured to engage the first support member and to inhibit the first support member from moving in a direction away from the body. The first restraining member and the cargo support surface cooperate to restrain the elongate cargo when the elongate cargo is disposed between the cargo support surface and the first restraining member.

In another embodiment, the vehicle includes, but is not limited to, a body having a cargo support surface that is configured to support the elongate cargo. The cargo support surface has a first opening defined therein. A first support member is housed within the first opening and is configured to move inwardly and outwardly with respect to the first opening. A restraining member is connected to the first support member and is oriented generally transversely thereto. The restraining member is configured to move towards and away from the cargo support surface as the first support member moves inwardly and outwardly with respect to the first opening. A first biasing member is connected to one of the first support member and the restraining member. The first biasing member is configured to bias the restraining member towards the cargo support surface. The first biasing member, the restraining member and the cargo support surface cooperate to restrain the elongate cargo when the elongate cargo is disposed between the cargo support surface and the restraining member.

In yet another embodiment, the system is configured for use with a vehicle having a body having a cargo support surface. The system includes, but is not limited to, a support member that is configured to be housed within an opening in the cargo support surface and is further configured for movement inwardly and outwardly with respect to the opening. A restraining member is connected to the support member and is oriented generally transversely thereto. The restraining member is configured to move towards and away from the cargo support surface as the support member moves inwardly and outwardly with respect to the opening, and is further configured to compress the elongate cargo against the cargo support surface. The support member is configured to be engaged by the body in a manner that inhibits the support member from moving in a direction away from the body and the restraining member is configured to cooperate with the cargo support surface to restrain the elongate cargo when the elongate cargo is disposed between the cargo support surface and the restraining member.

### DESCRIPTION OF THE DRAWINGS

One or more embodiments will hereinafter be described in conjunction with the following drawing figures, wherein like numerals denote like elements, and

FIG. 1 is a simplified perspective view illustrating an embodiment of a vehicle adapted to carry elongate cargo;

FIG. 2 is a simplified perspective view illustrating a tailgate of the vehicle of FIG. 1 equipped with a restraining unit;

FIG. 3 is a simplified perspective view illustrating the tailgate of FIG. 2 with the restraining unit disposed in an extended position;

FIG. 4 is a simplified perspective view illustrating the tailgate of FIG. 3 with an exemplary elongate cargo resting on a cargo support surface of the tailgate;

FIG. 5 is a simplified perspective view illustrating the tailgate and the exemplary elongate cargo of FIG. 4 with the restraining member and the cargo support surface cooperating to restrain the exemplary elongate cargo;

FIG. 6 is a schematic cross sectional view of the tailgate of FIGS. 2-5, illustrating an embodiment of an engaging apparatus for controlling the extension and retraction of the restraining unit, with restraining unit disposed in a retracted position;

FIG. 7 is a schematic cross sectional view of the tailgate of FIG. 6, illustrating the restraining unit in an extended position and the exemplary elongate cargo resting on the cargo support surface;

FIG. 8 is a schematic cross sectional view of the tailgate of FIG. 7, illustrating the restraining unit in a partially retracted position and the exemplary elongate cargo compressed between the restraining member and the cargo support surface;

FIG. 9 is a schematic cross sectional view of the tailgate of FIGS. 2-5, illustrating another embodiment of a mechanism for controlling the extension and retraction of the restraining unit, with the restraining unit disposed in a retracted position;

FIG. 10 is a schematic cross sectional view of the tailgate of FIG. 9, illustrating the restraining unit in an extended position and the exemplary elongate cargo resting on the cargo support surface;

FIG. 11 is a schematic cross sectional view of the tailgate of FIG. 10, illustrating the restraining unit in a partially retracted position and the exemplary elongate cargo compressed between the restraining member and the cargo support surface;

FIG. 12 is a schematic side view illustrating a support member in an extended position and rotationally connected to restraining member;

FIG. 13 is a schematic side view illustrating the restraining member of FIG. 12 in a tilted orientation aligned with several items of elongate cargo;

FIG. 14 is a simplified perspective view illustrating another embodiment of a vehicle adapted to carry elongate cargo, the vehicle including two restraining units;

FIG. 15 is a simplified perspective view illustrating the vehicle of FIG. 14 with the restraining units in an extended position as an exemplary elongate cargo is loaded;

FIG. 16 is a simplified perspective view illustrating the vehicle of FIG. 15 with each of the restraining units in a partially retracted position and the exemplary elongate cargo compressed between the two restraining members and the cargo support surface;

FIG. 17 is a simplified perspective view illustrating yet another embodiment of a vehicle adapted to carry elongate cargo, the vehicle including a tailgate portion including a restraining unit, and the vehicle further including a brace member;

FIG. 18 is a simplified perspective view illustrating the embodiment of the vehicle of FIG. 17 with the restraining unit in an extended position, and the brace member in an upright position, each ready to receive an exemplary elongate cargo; and

FIG. 19 is a simplified perspective view illustrating the vehicle of FIG. 18 with the restraining unit in a partially retracted position and the exemplary elongate cargo compressed between the restraining member and the cargo support surface and inhibited from forward motion by the brace member.

### DETAILED DESCRIPTION

The following detailed description is merely exemplary in nature and is not intended to limit application and uses. Furthermore, there is no intention to be bound by any expressed or implied theory presented in the preceding technical field, background, brief summary or the following detailed description.

An improved vehicle adapted to carry elongate cargo and an improved system for use with a vehicle, the system improving the vehicle's ability to carry elongate cargo, are disclosed herein. In some examples, the vehicle may be a pickup truck. The pickup truck includes a body, such as a tailgate. The tailgate includes a cargo support surface that is configured to support an underside of the elongate cargo. The cargo support surface includes a pair of openings into an interior portion the tailgate. Each opening is configured to receive a support member, such as a post. The support member may be made from any suitable material or combination of suitable materials including plastic, ceramic, wood and/or metal. The support member may be a solid object, a plurality of interconnected solid objects, or it may be hollow. Each support member is configured to fit within the opening and is further configured to move inwardly and outwardly with respect to the opening. Each opening is aligned in the tailgate to support a respective support member in a generally upright orientation. Upper portions of each of the support members are attached to a restraining member. The restraining member may be made from any suitable material or combination of suitable materials including plastic, ceramic, wood and/or metal. The restraining member may be a solid object, a plurality of interconnected solid objects, or it may be hollow. The restraining member is oriented transversely to the support members and joins the two support members in a bridge-like fashion. The two support members and the restraining member together form a restraining unit that is configured to retract and extend from the tailgate as the support members move inwardly and outwardly with respect to the openings. When the restraining unit is in the retracted position, the restraining member covers a portion of the cargo support surface. When the restraining unit is extended, the cargo supporting surface is exposed. When the restraining unit is extended, the elongate cargo may be positioned on the cargo supporting surface, and then the restraining unit may be lowered on top of the elongate cargo.

The tailgate also includes an engaging apparatus that is configured to engage the support members. The engaging apparatus may be configured to inhibit the support members from moving in an outward direction with respect to the openings, and thereby inhibits extension of the restraining unit. The engaging apparatus may take any of a variety of different forms. For example, a high friction lining may be positioned in the openings to frictionally engage the support members and may be configured to selectively loosen and tighten around the support members. In another example, a latch mechanism may be incorporated into the tailgate to engage with latch engaging features on the support members. The latch may be selectively locked and unlocked to control the extension of the restraining unit. In another example, one or more springs may be employed to bias the restraining unit towards the retracted position.

With the elongate cargo sandwiched between the cargo support surface and the underside of the restraining member, and with the restraining member inhibited from extending, the restraining unit compresses the elongate cargo against the cargo support surface and, through a frictional engagement with the elongate cargo, will prevent the elongate cargo from moving laterally with respect to the vehicle.

A further understanding of the vehicle adapted to carry elongate cargo described above may be obtained through a review of the illustrations accompanying this application together with a review of the detailed description that follows.

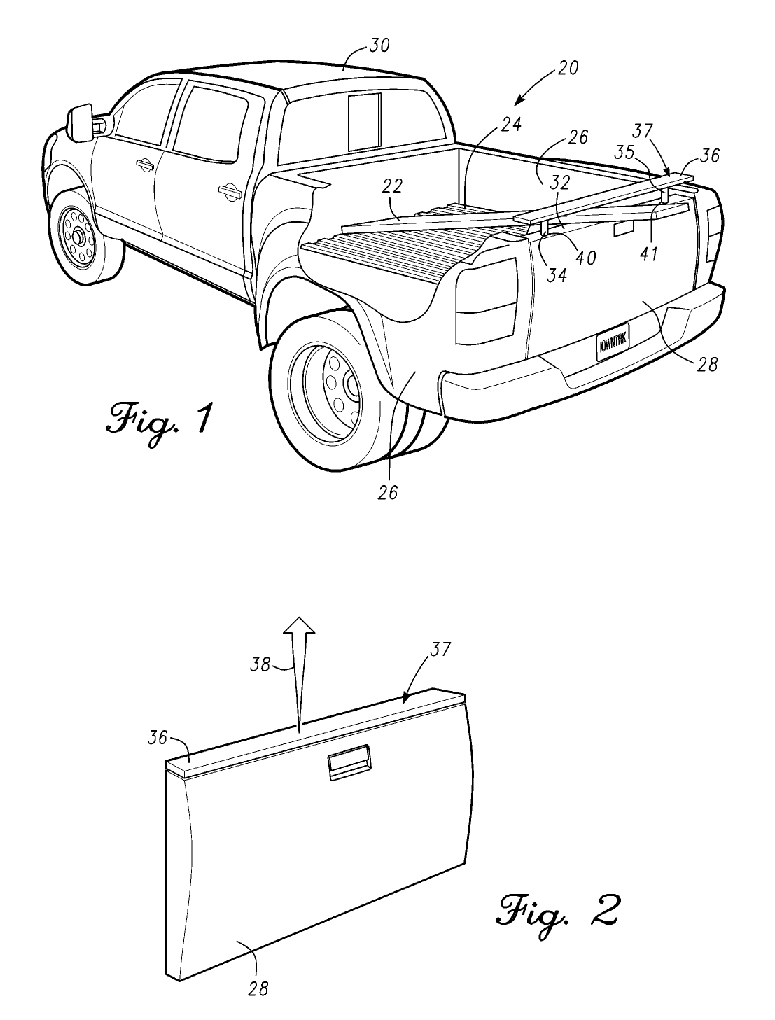

FIG. 1 is a simplified perspective view illustrating an embodiment of a vehicle 20 adapted to carry elongate cargo 22. While the illustrations and the detailed description below describe vehicle 20 as being a pickup truck, it should be understood that any type of vehicle may be adapted in the manner described herein. For example, the adaptations discussed herein may be implemented on other types of automobiles including, but not limited to, sports utility vehicles, mini-vans, full size vans, sedans, coupes, convertibles, and crossover vehicles. Additionally, the adaptations described herein may used on vehicles other than automobiles including, but not limited to, rail driven vehicles, water craft, aircraft and spacecraft without departing from the teachings of the present disclosure.

Elongate cargo 22 is illustrated as a single plank of wood. This is for purposes of illustration only. Vehicle 20 may also carry multiple planks of wood in the manner described below. Additionally, other types of elongate cargo may also be carried by vehicle 20. For example, sheets of plywood, pipes, poles, tools, garden implements and any other type of cargo having a generally elongate longitudinal dimension as compared with its lateral dimension may be carried by vehicle 20 in the manner described below.

Vehicle 20 includes a bed 24 suitable for supporting cargo. Bed 24 extends longitudinally in the direction of vehicle travel and laterally in a direction transverse to the direction of vehicle travel. Bed 24 is bordered by walls 26, tailgate 28, and a portion of vehicle cab 30. Bed 24, walls 26, tailgate 28 and vehicle cab 30 form an open box which is suitable for containing a wide variety of cargo. In some embodiments, instead of vehicle cab 30, a fourth wall is positioned at a forward end of bed 24 to close off a forward end of the open box.

Tailgate 28 is configured to move between an upright position and a lowered or extended position. When in the upright position, tailgate 28 forms one of the sides of the open box and when in the lowered position, tailgate 28 generally aligns with bed 24 to facilitate the loading and unloading of cargo.

Tailgate 28 includes a cargo support surface 32 comprising an upper portion of tailgate 28. In some embodiments, cargo support surface 32 may comprise a painted metal surface. In other embodiments, cargo support surface 32 may include a rubberized facing or a polymeric coating. In other embodiments, cargo support surface 32 may be coated with, or covered by, any other material that is effective to support cargo.

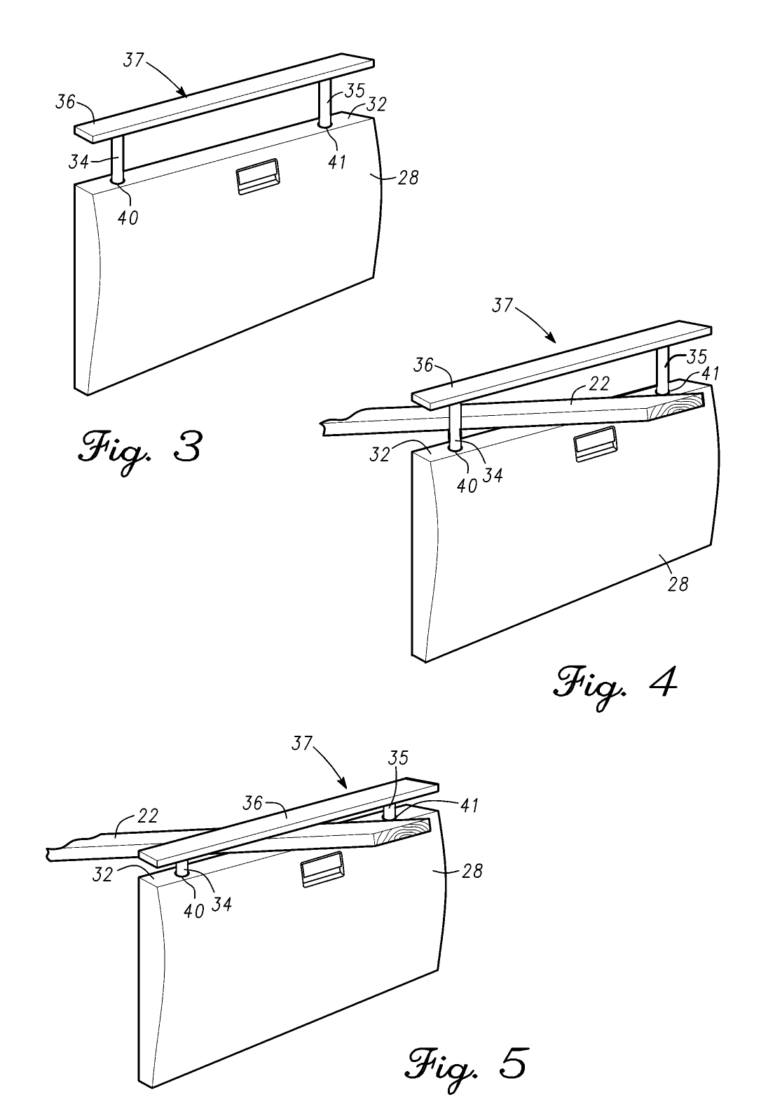

First opening 40 and second opening 41 (hereinafter referred to as “openings 40, 41”) in cargo support surface 32 (as best seen in FIG. 3) extend inwardly into tailgate 28. Openings 40,41 are configured to receive a first support member 34 and a second support member 35, respectively (hereinafter referred to as “support members 34, 35”). In the illustrated example, openings 40, 41 in cargo support surface 32 are generally circular and support members 34, 35 are generally cylindrical and configured to move through the openings in an inward and outward direction. In other embodiments, support members 34, 35 and openings 40, 41 in cargo support surface 32 may have any suitable shape that is configured to permit support members 34, 35 to move inwardly and outwardly with respect to the openings in cargo support surface 32.

A restraining member 36 is attached to the upper portion of first support member 34 and second support member 35 and extends therebetween, bridging the distance between the top portions of support members 34, 35. In the illustrated example, restraining member 36 is a rectangular, generally planar, substantially rigid component. In other examples, restraining member 36 may be shaped and configured to appear to be the top portion of tailgate 28. In other embodiments, restraining member 36 may be a flexible material. In some embodiments, restraining member 36 may include a high friction component, such as a rubber facing, or a compressible component, such as a foam cushion, on an underside surface of restraining member 36 to facilitate restraint of elongate cargo 22. In other examples, an underside of restraining member 36 may be contoured, such as with an undulating surface or a surface that forms discreet compartments to accommodate individual items of cargo. In other examples, restraining member 36 may take any form effective to restrain cargo.

Restraining member 36 and support members 34, 35, comprise a system for use with a vehicle that enables the vehicle to carry elongate cargo and will collectively be referred to herein as restraining unit 37. Restraining unit 37 is configured to retract within, and to extend from, tailgate 28. When extracted, restraining unit 37 exposes cargo support surface 32 and permits the loading of cargo items onto cargo support surface 32. Once the items of cargo are loaded onto cargo support surface 32, restraining unit 37 may be partially retracted within tailgate 28 and the underside of restraining member 36 will come to rest on top of the cargo items. This is illustrated in FIG. 1. As shown in FIG. 1, elongate cargo 22 has a length which exceeds the longitudinal dimension of bed 24. One end of elongate cargo 22 abuts up against the lower portion of vehicle cab 30 and the other end has been placed onto cargo support surface 32. Restraining unit 37 has been partially retracted, and restraining member 36 rests on top of elongate cargo 22, compressing it against cargo support surface 32. The compressive forces may be caused by gravity, by a spring that biases restraining member 36 towards the retracted position, by a compression member attached to an underside of restraining member 36, by any combination thereof, or by any other means effective to compress restraining member against elongate cargo 22. The compressive forces acting on elongate cargo 22 inhibit elongate cargo 22 from moving laterally.

Tailgate 28 also includes an engaging apparatus (discussed below), such as a latch assembly or a spring assembly, that is configured to control and/or inhibit restraining unit 37 from being extended. Such an engaging apparatus may be engaged or disengaged selectively by an operator to alternately permit and inhibit the extension of restraining unit 37.

In other embodiments, a greater or lesser number of support members may be employed. Additionally, restraining unit 37 may be mounted to portions of vehicle 20 other than tailgate 28. In still other embodiments, multiple restraining units 37 may be mounted to vehicle 20 and may be arranged to cooperate with one another to restrain cargo.

FIG. 2 is a simplified perspective view illustrating tailgate 28 of vehicle 20 of FIG. 1 equipped with restraining unit 37. In FIG. 2, tailgate 28 is illustrated with restraining unit 37 fully retracted into tailgate 28. In the retracted position, support members 34, 35 are not visible. Additionally, restraining member 36 completely covers cargo support surface 32. In some embodiments, a top portion of restraining member 36 may also be configured to support cargo, such as through the mounting of rubber facing or the use of plastic coatings. In some embodiments, restraining unit 37 may be extended by applying force in the direction indicated by the illustrated arrow. In some embodiments, the engaging apparatus may need to be disengaged before restraining unit 37 can be extended.

FIG. 3 is a simplified perspective view illustrating tailgate 28 of FIG. 2 with restraining unit 37 disposed in an extended position. In this view, openings 40, 41 in cargo support surface 32 are clearly visible. Openings 40, 41 are configured as circular openings and support members 34, 35 are generally cylindrical and configured to fit within openings 40 and to move inwardly and outwardly with respect thereto. With restraining unit 37 in the extended position, elongate cargo 22 may be inserted into the opening formed by cargo support surface 32 and restraining unit 37.

FIG. 4. is a simplified perspective view illustrating tailgate 28 of FIG. 3 with elongate cargo 22 resting on cargo support surface 32. Once elongate cargo 22 is positioned on cargo support surface 32, an operator may apply a downward force (i.e., in the direction indicated by the illustrated arrow) on an upper surface of restraining member 36 to retract restraining unit 37.

FIG. 5 is a simplified perspective view illustrating tailgate 28 and elongate cargo 22 of FIG. 4 with restraining member 36 and cargo support surface 32 cooperating to restrain elongate cargo 22. When the underside of restraining member 36 compresses elongate cargo 22 against cargo support surface 32, frictional forces act on elongate cargo 22 to inhibit elongate cargo 22 from moving laterally with respect to vehicle 20. This inhibition can be enhanced by the materials selected as a facing for the underside of restraining member 36 and for cargo support surface 32. For example, the underside of restraining member 36 and cargo support surface 32 may be covered by a rubber material to enhance the grip acting on elongate cargo 22.

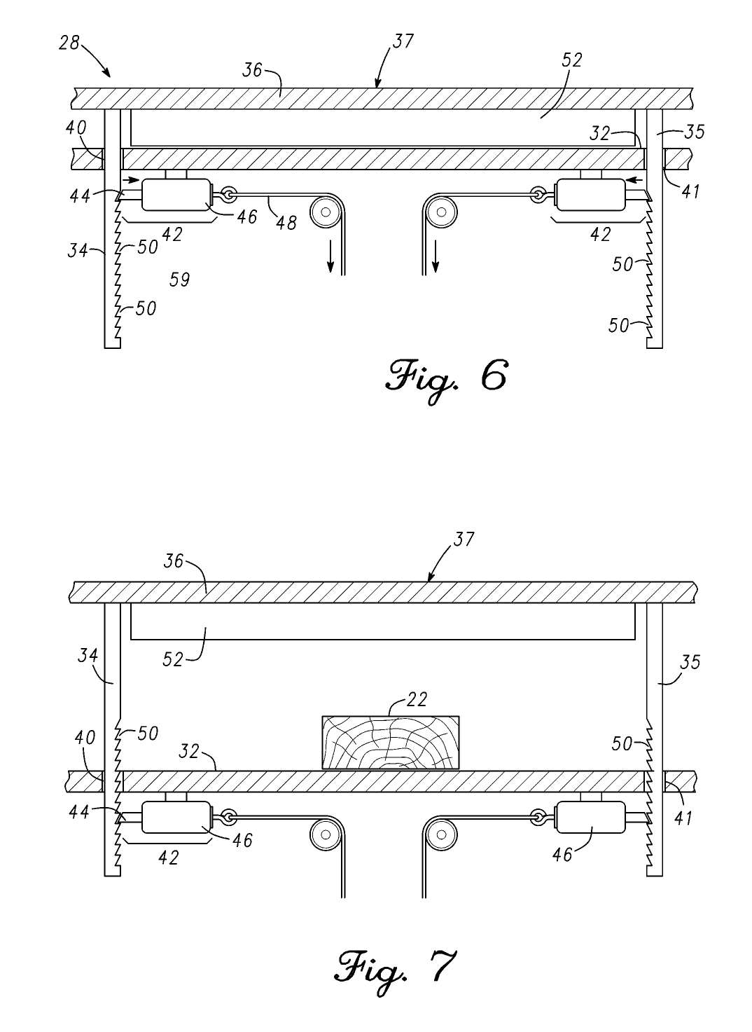

FIG. 6. is a schematic cross sectional view of tailgate 28 of FIGS. 2-5, illustrating an embodiment of an engaging apparatus 42 for controlling the extension and retraction of restraining unit 37, with restraining unit 37 disposed in a retracted position. In FIG. 6, engaging apparatus 42 is a latch mechanism including a pin 44 configured to move in and out of a pin housing 46. Pin 44 is biased by a spring (not shown) towards an extended position. Pin housing 46 is fixedly mounted to an underside of cargo supporting surface 23. In other embodiments, pin housing 46 may be attached to any other suitable surface of tailgate 28. In FIG. 6, two engaging apparatuses 42 are employed to engage support members 34, 35. In other embodiments of vehicle 20, a greater or lesser number of engaging apparatuses may be employed.

A cable 48 is connected to pin 44 and, when cable pulled, causes pin 44 to retract within pin housing 46. A distant end of cable 48 may be connected to a latch, a button, a switch, or any other suitable mechanism which, when actuated by the user, remotely causes pin 44 to retract. In the illustrated embodiment, tailgate 28 includes two engaging apparatuses 42 that are configured to work cooperatively to control the extension of restraining unit 37.

Support members 34, 35 each include a plurality of latch engaging features 50 which are configured to receive an end portion of pin 44. In the illustrated embodiment, latch engaging features 50 include notches formed in a surface of first support member 34. In other embodiments, latch engaging features 50 may comprise openings or recesses that are configured to receive the end portions of pin 44. In other embodiments, other configurations effective to engage pin 44 may be employed.

Pin 44 and latch engaging features 50 are configured to cooperate to inhibit first support member 34 from extending from tailgate 28 while an end portion of pin 44 is received within latch engaging feature 50. When an operator pulls on cable 48, such as through the actuation of a latch, switch, and/or button, pin 44 refracts within pin housing 46 and first support member 34 is free to extend.

In the embodiment illustrated in FIG. 6, a compressible member 52 is attached to the underside of restraining member 36. Compressible member 52 may be made of any compressible material, including, but not limited to, rubber and foam materials. Compressible member 52 can provide additional down force on elongate cargo 22 when restraining unit 37 is refracted and restraining member 36 is compressed against elongate cargo 22. In some embodiments, compressible member 52 can be compressed by a distance that is at least equal to the distance between consecutive latch engaging features 50. This compressibility ensures that compressible member 52 will be in compressive contact with any item of elongate cargo when restraining unit 37 is retracted. In the illustrated embodiment, compressible member 52 is compressed when restraining unit 37 is in the retracted position.

FIG. 7 is a schematic cross sectional view of tailgate 28 of FIG. 6, illustrating restraining unit 37 in an extended position and elongate cargo 22 resting on cargo support surface 32. In some embodiments, the weight of restraining unit 37 and the spring constant of the springs acting on pins 44 may be arranged such that restraining unit 37 can be supported in the extended position by engaging apparatuses 42 alone. In other embodiments, the operator may need to hold restraining unit 37 in the extended position or otherwise inhibit restraining unit 37 from retracting into tailgate 28 in order to prevent restraining unit 37 from retracting under the force of gravity while elongate cargo 22 is being loaded.

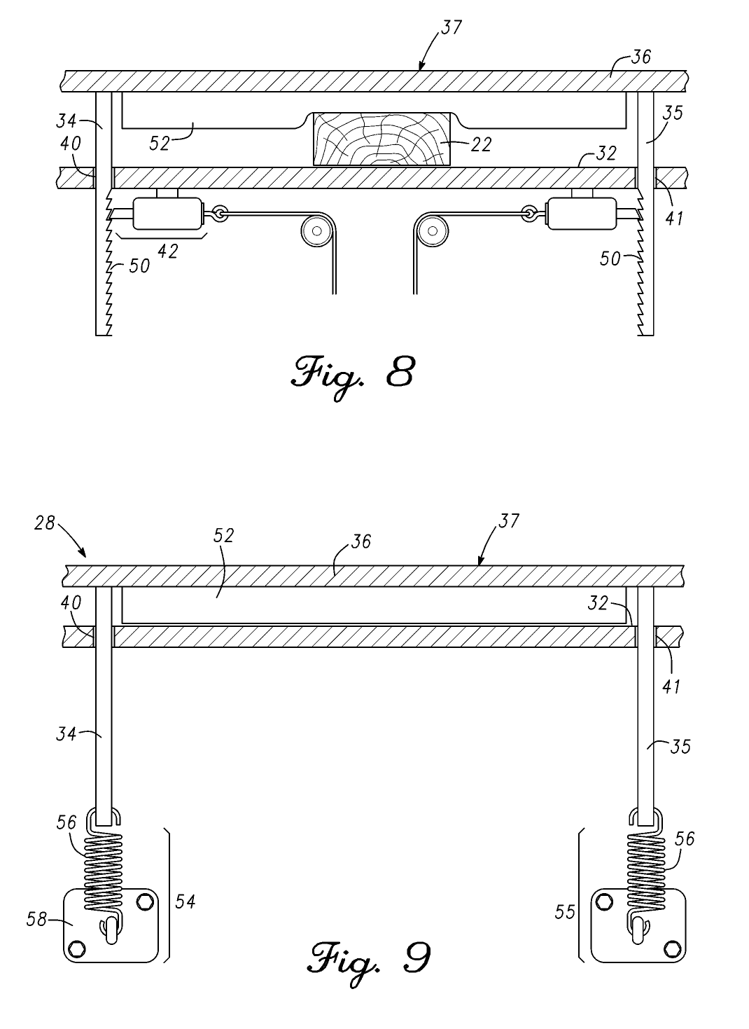

FIG. 8 is a schematic cross sectional view of tailgate 28 of FIG. 7, illustrating restraining unit 37 in a partially retracted position and elongate cargo 22 compressed between restraining member 36 and cargo support surface 32. As illustrated, compressible member 52 is compressed against elongate cargo 22. This compression adds to the down force acting on elongate cargo 22 and further restrains elongate cargo 22 from lateral movement.

FIG. 9 is a schematic cross sectional view of tailgate 28 of FIGS. 2-5, illustrating an alternate embodiment of an engaging apparatus for controlling the extension and retraction of restraining unit 37, with restraining unit 37 disposed in a retracted position. In the illustrated embodiment, tailgate 28 includes a first biasing member or first engaging apparatus 54 and a second biasing member or second engaging apparatus 55 for use respectively with support members 34, 35. First engaging apparatus 54 and second engaging apparatus 55 will hereinafter be referred to collectively as engaging apparatuses 54, 55. Engaging apparatuses 54, 55 each include a spring 56 and a spring mount 58. Spring mount 58 is fixedly mounted to a wall of tailgate 28. In other embodiments, spring mount 58 may be mounted to any suitable portion of tailgate 28 or to any other suitable surface on vehicle 20. Spring 56 is attached at one end to spring mount 58 and at the other end to support members 34, 35. In other embodiments, spring 56 may be attached to restraining member 36 instead of to support members 34, 35. In the illustrated embodiment, each spring 56 is configured to be in tension when restraining unit 37 is in the retracted position. This configuration will provide down force on restraining unit 37 to assist in compressing elongate cargo 22 between restraining member 36 and cargo support surface 32.

To extend restraining unit 37, an operator may pull in an upward direction on restraining member 36. Some embodiments of vehicle 20 may provide a handle or other grip member on a top portion of restraining member 36 to facilitate such movement.

While the embodiment illustrated in FIG. 9 shows the use of a coil spring in conjunction with engaging apparatuses 54, 55, other biasing devices may alternatively be employed without departing from the teachings of the present disclosure. For example, an elastic material, a gas spring, and any other member or device configured to pull restraining unit 37 towards the retracted position may be employed.

In the embodiment illustrated in FIG. 9, compressible member 52 is attached to an underside of restraining member 36. Compressible member 52 may serve to provide added compressive down force on elongate cargo 22 and/or it may serve to provide a cushion to prevent excessive jarring in the event of an uncontrolled retraction of restraining unit 37 into tailgate 28 and/or it may provide a high friction surface for engagement with elongate cargo 22.

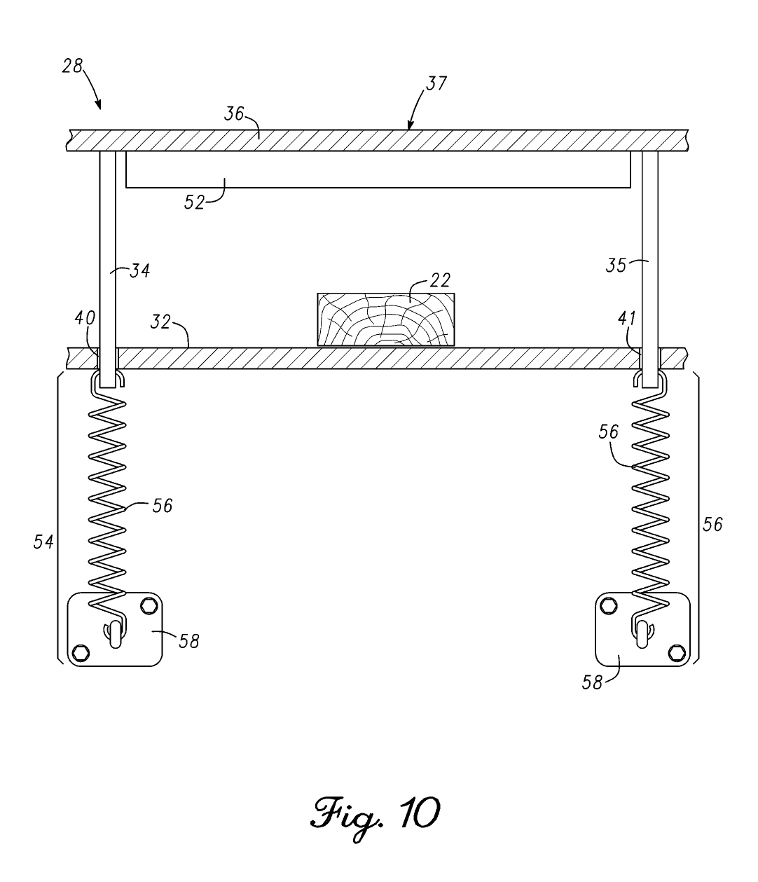

FIG. 10 is a schematic cross sectional view of tailgate 28 of FIG. 9, illustrating restraining unit 37 in an extended position and elongate cargo 22 resting on cargo support surface 32. Springs 56 have been extended, increasing the tension acting on restraining unit 37 and thus increasing the down force available to compress elongate cargo 22 between restraining member 36 and cargo support surface 32.

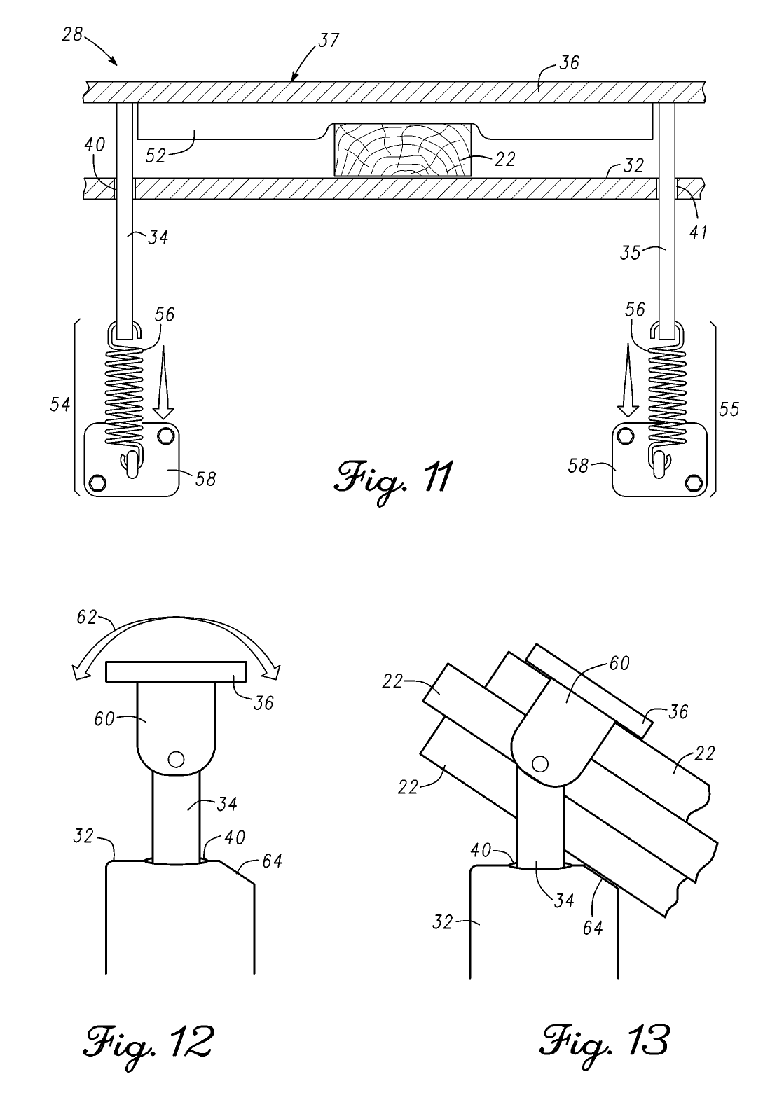

FIG. 11 is a schematic cross sectional view of tailgate 28 of FIG. 10, illustrating restraining unit 37 in a partially retracted position and elongate cargo 22 compressed between restraining member 36 and cargo support surface 32. Compressible member 52 is compressed against elongate cargo 22, further increasing the compressive force acting on elongate cargo 22 and further inhibiting its lateral movement.

Some embodiments of vehicle 20 may employ both a latching mechanism such as engaging apparatus 42 and a biasing mechanism such as engaging apparatuses 54, 55. Such an embodiment would both bias restraining unit 37 towards the retracted position and would also inhibit movement of restraining unit 37 towards the extended position.

FIG. 12 is a schematic side view illustrating first support member 34 in an extended position rotationally connected to restraining member 36. First support member 34 is rotationally connected to restraining member 36 by a hinge 60. In other embodiments, any mechanism or apparatus effective to form a rotational connection between first support member 34 and restraining member 36 may be employed.

Hinge 60 permits restraining member 36 to swivel about an end of first support member 34 in the direction indicated by arrow 62. This permits an underside surface of restraining member 36 to align with an upwardly facing surface of elongate cargo 22 and thereby increase the area of contact between restraining member 36 and elongate cargo 22.

In FIG. 12, cargo support surface 32 includes a beveled portion 64. In some embodiments, beveled portion 64 may extended across an entire length of cargo support surface 32. Beveled portion 64 is configured to align with an underside of elongate cargo 22 to increase the area of contact between elongate cargo 22 and cargo support surface 32 which, in turn, provides greater frictional engagement with elongate cargo 22.

FIG. 13 is a schematic side view illustrating restraining member 36 of FIG. 12 supported in a tilted orientation aligned with several items of elongate cargo 22. As illustrated, the entire underside surface of restraining member 36 is in contact with elongate cargo 22, providing enhanced frictional engagement with elongate cargo 22. Similarly, the entire surface of beveled portion 64 is in contact with an underside of elongate cargo 22 and also provides enhanced frictional engagement with elongate cargo 22.

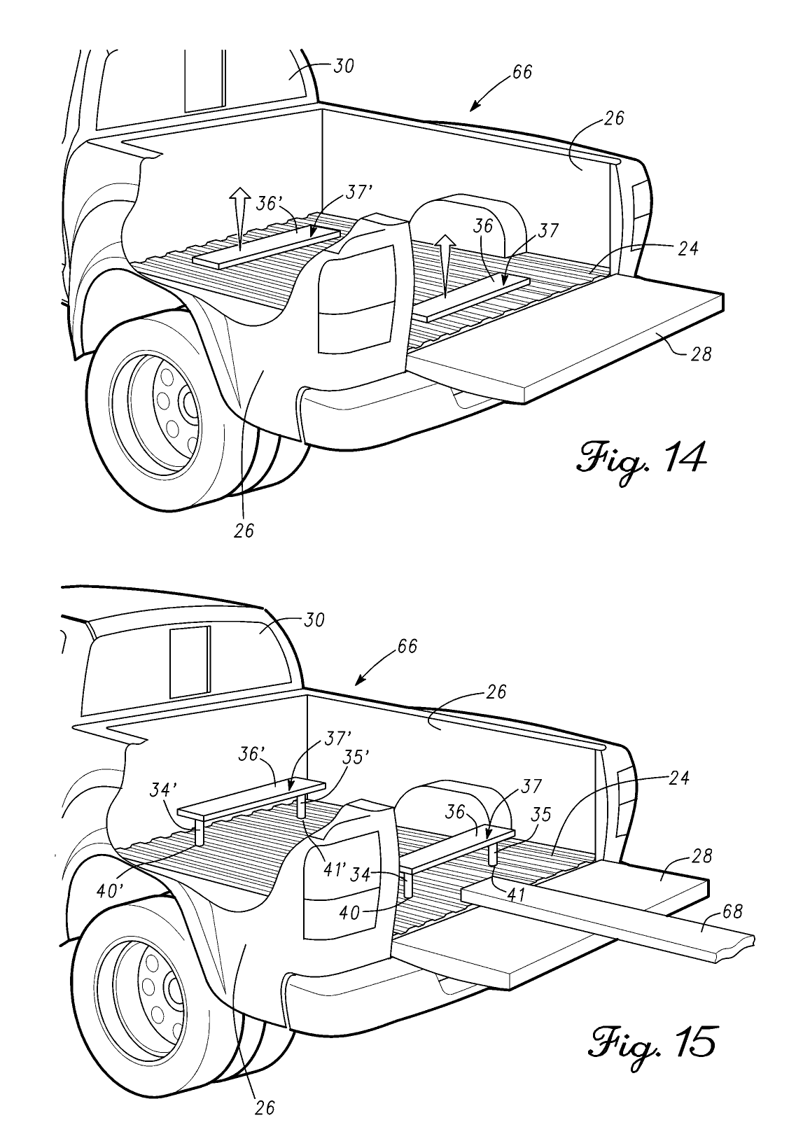

FIG. 14 is a simplified perspective view illustrating another embodiment of a vehicle 66 adapted to carry elongate cargo, the vehicle including two restraining units 37 and 37′. The cargo carrying solution presented by vehicle 66 addresses situations where the length of an elongate cargo is less than the longitudinal dimension of bed 24. Although the elongate cargo will fit within the box formed by walls 26, tailgate 28, and vehicle cab 30, it may, nevertheless, be desirable to restrain the elongate cargo from moving laterally while resting on bed 24.

As illustrated in FIG. 14, vehicle 66 includes two restraining units mounted to bed 24. Restraining unit 37 is mounted in a rear portion of bed 24 and restraining unit 37′ is mounted in a front portion of bed 24. Restraining unit 37 and restraining unit 37′ will be collectively referred to herein as “restraining units 37, 37′”. In FIG. 14, restraining units 37, 37′ are in the retracted position such that only their respective restraining members 36, 36′ are visible. In some embodiments, bed 24 may be configured to permit each restraining unit to retract such that the upper surfaces of restraining members 36, 36′ are substantially flush with the remainder of bed 24. Vehicle 66 may also include two engaging apparatuses 42 (see FIGS. 6-8 and FIGS. 9-11) to control the extension of restraining units 37, 37′ from bed 24.

FIG. 15 is a simplified perspective view illustrating vehicle 66 of FIG. 14 with restraining units 37, 37′ in an extended position as an elongate cargo 68 is loaded. Restraining unit 37 includes support members 34, 35 and a transversely mounted restraining member 36. Restraining unit 37′ includes a third support member 34′ and a fourth support member 35′ (hereinafter referred to collectively as support members 34′, 35′”) and a transversely mounted restraining member 36′. Bed 24 includes four openings. First opening 40 and second opening 41 receive first support member 34 and second support member 35, respectively, of restraining unit 37. Third opening 40′ and fourth opening 41′ receive third support member 34′ and fourth support member 35′ of restraining unit 37′. In other embodiments, additional restraining units may also be employed. Elongate cargo 68 is positioned between first support member 34 and second support member 35 and also between third support member 34′ and fourth support member 35′ such that each end of elongate cargo 68 will be restrained by restraining unit 37 and restraining unit 37′, respectively.

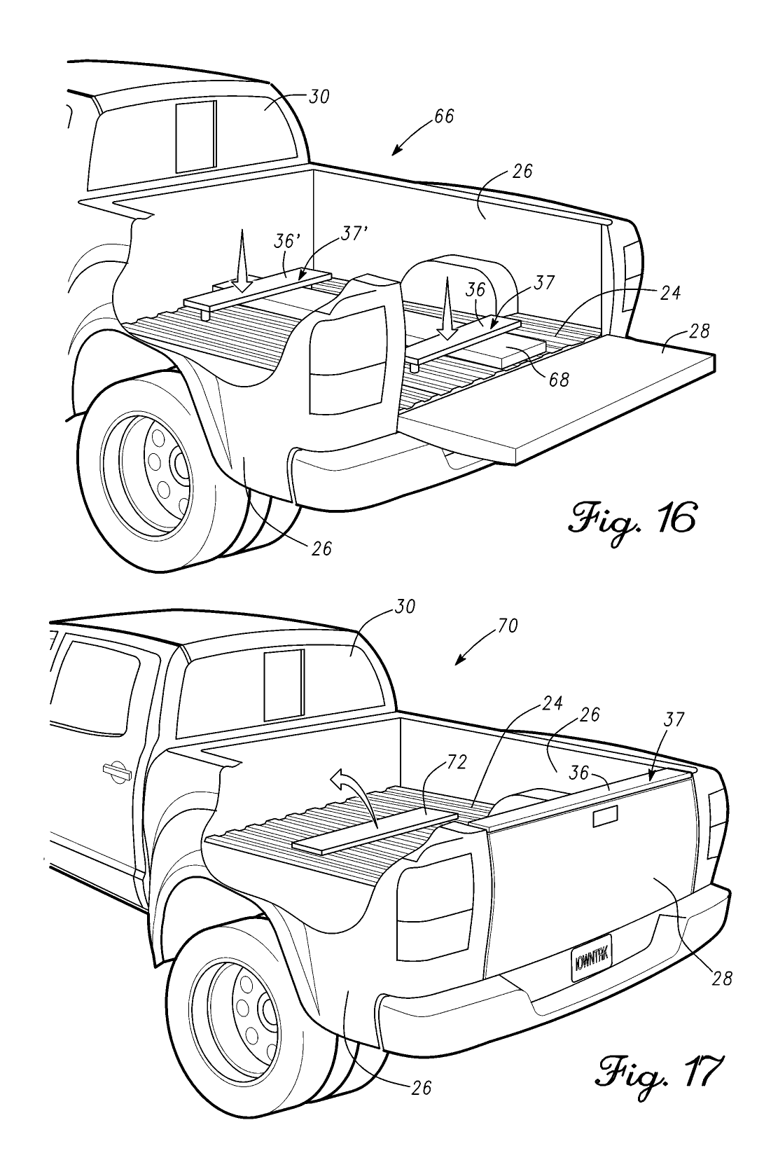

FIG. 16 is a simplified perspective view illustrating vehicle 66 of FIG. 15 with restraining units 37, 37′ in a partially retracted position and elongate cargo 68 compressed between restraining members 36 and bed 24 and between restraining member 36′ and bed 24. The compressive force acting on elongate cargo 68 by each restraining member 36, 36′ will inhibit elongate cargo 68 from moving laterally during maneuvering of vehicle 66.

FIG. 17 is a simplified perspective view illustrating yet another embodiment of a vehicle 70 adapted to carry an elongate cargo. Vehicle 70 includes tailgate 28 including restraining unit 37, and further includes a brace member 72. Vehicle 70 is adapted to carry elongate cargo that is both longer and shorter than the longitudinal dimension of bed 24. Vehicle 70 includes restraining unit 37 mounted to tailgate 28 which is configured to operate in the manner discussed above with respect to FIGS. 1-13 to carry elongate cargo having a length that exceeds the longitudinal dimension of bed 24.

Vehicle 70 includes brace member 72 to permit vehicle 70 to carry elongate cargo having a length that is less than the longitudinal dimension of bed 24. Brace member 72 is a body mounted in bed 24. In some embodiments, brace member 72 is mounted such that it protrudes above the surface of bed 24 and serves as a backstop against which one end of an elongate cargo may be propped to prevent the elongate cargo from sliding towards a forward portion of bed 24. Brace member 72 may have a generally rectangular shape, the shape of a horseshoe, or it may have any other suitable shape effective for preventing the elongate cargo from sliding in a forward direction.

In other embodiments, such as the one illustrated in FIG. 17, brace member 72 is rotationally connected to bed 24 and is configured to move between a lowered position that is substantially parallel to the upper surface of bed 24 and an upright position. When brace member 72 is in the upright position, it may serve as a backstop for multiple items of elongate cargo stacked on top of one another.

In still other embodiments, brace member 72 may be recessed below the upper surface of bed 24 such that an upper surface of brace member 72 is substantially flush with an upper surface of bed 24 when brace member 72 is in the lowered position. When brace member 72 is rotated to its upright position, an end of the elongate cargo may be propped up against the walls of the recess, with additional items of elongate cargo being propped against the underside of brace member 72.

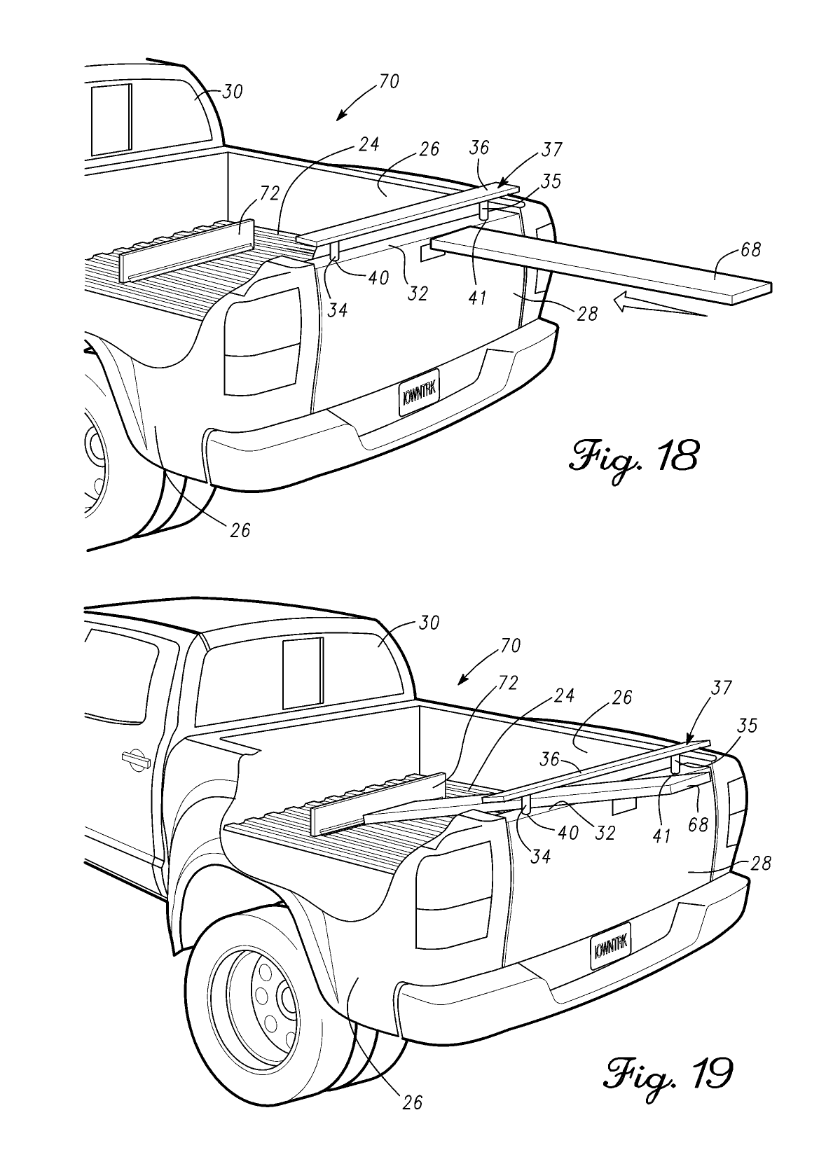

FIG. 18 is a simplified perspective view illustrating vehicle 70 of FIG. 17 with restraining unit 37 in an extended position, and brace member 72 in an upright position, each ready to receive elongate cargo 68. Elongate cargo 68 is loaded through the opening formed by restraining unit 37 and cargo support surface 32 and slid along bed 24 until an end of elongate cargo 68 comes to rest against brace member 72.

FIG. 19 is a simplified perspective view illustrating vehicle 70 of FIG. 18 with restraining unit 37 in a partially retracted position and elongate cargo 68 compressed between restraining member 36 and cargo support surface 32 and inhibited from forward motion by brace member 72. In the illustrated example, restraining member 36 is rotationally mounted to first support member 34, thus permitting restraining member 36 to pivot so as to come into alignment with elongate cargo 68 and thereby provide a greater surface area over which to frictionally engage elongate cargo 68.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration in any way. Rather, the foregoing detailed description will provide those skilled in the art with a convenient road map for implementing the exemplary embodiment or exemplary embodiments. It should be understood that various changes can be made in the function and arrangement of elements without departing from the scope as set forth in the appended claims and the legal equivalents thereof.

What is claimed is:

1. A vehicle adapted to carry elongate cargo, the vehicle comprising:
a body having a cargo support surface configured to support the elongate cargo, the cargo support surface having a first opening defined therein;
a first support member housed within the first opening and configured to move inwardly and outwardly with respect to the first opening; and
a first restraining member connected to the first support member and oriented generally transversely thereto, the first restraining member being configured to move towards and away from the cargo support surface as the first support member moves inwardly and outwardly with respect to the first opening, and further configured to compress the elongate cargo against the cargo support surface,
wherein the body is configured to engage the first support member and to inhibit the first support member from moving in a direction away from the body and wherein the first restraining member and the cargo support surface cooperate to restrain the elongate cargo when the elongate cargo is disposed between the cargo support surface and the first restraining member.

2. The vehicle of claim 1, wherein the first restraining member is a substantially planar body.

3. The vehicle of claim 2, further comprising a compressible member disposed on an underside of the first restraining member, the compressible member being configured to engage the elongate cargo to facilitate restraint of the elongate cargo.

4. The vehicle of claim 1 further comprising a second support member, wherein:
the cargo support surface has a second opening defined therein, the second opening being spaced apart from the first opening,
the second support member is housed within the second opening and is configured to move inwardly and outwardly with respect to the second opening,
the first restraining member is connected to the second support member and is oriented generally transversely thereto, the first restraining member being configured to move towards and away from the cargo support surface as the first support member and the second support member move inwardly and outwardly with respect to the first opening and the second opening, respectively, and
the body is configured to engage the second support member and to inhibit the second support member from moving in the direction away from the body.

5. The vehicle of claim 1, wherein the body includes a latch and wherein the first support member includes a plurality of latch engaging features extending along a length of the first support member, each of the plurality of latch engaging features being configured to engage the latch, the plurality of latch engaging features being arranged to cooperate with the latch to support the first support member at a plurality of heights above the cargo support surface, and wherein the latch and each of the plurality of latch engaging features are configured to cooperate to inhibit the first support member from moving in the direction away from the body.

6. The vehicle of claim 5, further comprising a compressible member disposed on an underside of the first restraining member, the compressible member being configured to engage the elongate cargo to facilitate restraint of the elongate cargo, the compressible member being further configured to compress by an amount approximately equal to a distance between two of the plurality of latch engaging features.

7. The vehicle of claim 1, wherein the first restraining member is rotatably attached to the first support member, whereby the first restraining member pivots with respect to the first support member to align with an upper surface of the elongate cargo when the cargo support surface and the first restraining member cooperate to restrain the elongate cargo.

8. The vehicle of claim 1, wherein the cargo support surface includes a beveled portion.

9. The vehicle of claim 1, further comprising a brace member mounted to the vehicle, the brace member being spaced apart from the cargo support surface, the brace member being configured to support an end of the elongate cargo when an opposite end of the elongate cargo rests on the cargo support surface.

10. The vehicle of claim 9, wherein the brace member is retractably mounted to the vehicle.

11. The vehicle of claim 1, wherein the cargo support surface has a third opening defined therein, the third opening being spaced apart from the first opening, the vehicle further comprising:
a third support member housed within the third opening and configured to move inwardly and outwardly with respect to the third opening; and
a second restraining member connected to the third support member and oriented generally transversely thereto, the second restraining member being configured to move towards and away from the cargo support surface as the third support member moves inwardly and outwardly with respect to the third opening,
wherein the body is configured to engage the third support member and to inhibit the third support member from moving in the direction away from the body, wherein the first restraining member, the second restraining member, and the cargo support surface cooperate to restrain the elongate cargo when the elongate cargo is disposed between the cargo support surface and the first restraining member and also between the cargo support surface and the second restraining member.

12. The vehicle of claim 11, wherein the first restraining member and the second restraining member are substantially planar bodies.

13. A vehicle adapted to carry elongate cargo, the vehicle comprising:
a body having a cargo support surface configured to support the elongate cargo, the cargo support surface having a first opening defined therein;
a first support member housed within the first opening and configured to move inwardly and outwardly with respect to the first opening;
a restraining member connected to the first support member and oriented generally transversely thereto, the restraining member being configured to move towards and away from the cargo support surface as the first support member moves inwardly and outwardly with respect to the first opening; and
a first biasing member connected to one of the first support member and the restraining member, the first biasing member configured to bias the restraining member towards the cargo support surface,
wherein the first biasing member, the restraining member and the cargo support surface cooperate to restrain the elongate cargo when the elongate cargo is disposed between the cargo support surface and the restraining member.

14. The vehicle of claim 13, wherein the first biasing member comprises a spring.

15. The vehicle of claim 13, further comprising a compressible member disposed on an underside of the restraining member, wherein the restraining member is configured to compress the elongate cargo against the cargo support surface and wherein the compressible member is configured to engage the elongate cargo to facilitate restraint of the elongate cargo.

16. The vehicle of claim 13, further comprising a second support member and a second biasing member, wherein:
the cargo support surface has a second opening defined therein, the second opening being spaced apart from the first opening,
the second support member is housed within the second opening and is configured to move inwardly and outwardly with respect to the second opening,
the restraining member is connected to the second support member and is oriented generally transversely thereto, the restraining member being configured to move towards and away from the cargo support surface as the first support member and the second support member move inwardly and outwardly with respect to the first opening and the second opening, respectively,
the second biasing member is connected to one of the second support member and the restraining member, the second biasing member configured to bias the restraining member towards the cargo support surface, and
the second biasing member, the restraining member and the cargo support surface cooperate to restrain the elongate cargo when the elongate cargo is disposed between the cargo support surface and the restraining member.

17. The vehicle of claim 13, wherein the restraining member is rotatably attached to the first support member, whereby the restraining member may pivot with respect to the first support member to come into alignment with the elongate cargo.

18. The vehicle of claim 13, further comprising a brace member mounted to the vehicle, the brace member being spaced apart from the cargo support surface, the brace member being configured to support an end of the elongate cargo when an opposite end of the elongate cargo rests on the cargo support surface.

19. A system for use with a vehicle having a body having a cargo support surface, the system enabling the vehicle to carry elongate cargo, the system comprising:
a support member configured to be housed within an opening in the cargo support surface and further configured for movement inwardly and outwardly with respect to the opening; and
a restraining member connected to the support member and oriented generally transversely thereto, the restraining member being configured to move towards and away from the cargo support surface as the support member moves inwardly and outwardly with respect to the opening, and further configured to compress the elongate cargo against the cargo support surface,
wherein the support member is configured to be engaged by the body in a manner that inhibits the support member from moving in a direction away from the body and wherein the restraining member is configured to cooperate with the cargo support surface to restrain the elongate cargo when the elongate cargo is disposed between the cargo support surface and the restraining member.

20. The vehicle of claim 19, wherein the restraining member is rotatably attached to the support member, whereby the restraining member pivots with respect to the support member to align with an upper surface of the elongate cargo when the elongate cargo is disposed between the cargo support surface and the restraining member.
